(19) United States
(12) Patent Application Publication
(10) Pub. No.: US 2012/0253945 A1
(43) Pub. Date: Oct. 4, 2012

(54) BID TRAFFIC ESTIMATION

(75) Inventors: Bin Gao, Beijing (CN); Tie-Yan Liu, Beijing (CN); Tao Qin, Beijing (CN); Zeyong Xu, Beijing (CN); Jianhua Hu, Mianyang (CN); Wei-Ying Ma, Beijing (CN)

(73) Assignee: Microsoft Corporation, Redmond, WA (US)

(21) Appl. No.: 13/078,454

(22) Filed: Apr. 1, 2011

(51) Int. Cl. G06Q 30/00; G06F 15/18

(52) U.S. Cl. 705/14.71; 706/12

(57) ABSTRACT

Some implementations provide techniques for estimating impression numbers. For example, a log of advertisement bidding data may be used to generate and train an impression estimation model. In some implementations, an impression estimation component may use a boost regression technique to determine a predicted impression value range based on a proposed bid received from an advertiser. For example, the predicted impression value range may be determined based on a predicted estimation error. Additionally, in some instances, the predicted impression value range may be evaluated using one or more evaluation metrics.

### BACKGROUND

In online advertising services, such as those associated with commercial search services, advertisers may submit bids to have their advertisements associated with particular keywords. When a user of the search service submits a search query, the advertising service may select one or more advertisements to be displayed to the user along with search results. The display of an advertisement to a user is commonly referred to as an “impression.” Sometimes a user may select or click on a displayed advertisement included with the search results, resulting in the user's browser displaying a webpage (i.e., a “landing page”) associated with the advertisement. This is commonly referred to as a “click” or “click-through.”

An advertisement may be selected for display with search results based on both the bid amount submitted by the advertiser and other factors, such as the relevance of the advertiser's keyword and the advertisement to the search query. For example, advertisements having a high bid amount and high keyword relevance may typically be expected to have a higher number of impressions than advertisements with a low bid amount and/or low keyword relevance. Additionally, because advertisers generally desire a high number of impressions for an acceptable bid, the advertisers may constantly tune their bid amounts over time based on their obtained impression numbers.

To aid advertisers in tuning their bid amounts, an advertising service may provide an estimate of an expected number of impressions for a particular bid amount. For example, the advertising service may use data simulation or interpolation to estimate that if the advertiser changes the bid amount from $0.80 to $1.59, the advertiser might expect that the number of impressions will increase from 698 to 747. However, due to the dynamic nature of the advertising bidding system and the potential for random actions by advertisers, the estimated impression values provided by an advertising service may be inaccurate or unreliable, which can lead to advertiser dissatisfaction.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein present techniques and systems for impression number estimation to provide a range of estimated impression values. For example, the range of estimated impression values may provide advertisers with a realistic estimation, and may assist advertisers in adjusting advertisement-keyword bid amounts accordingly.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 is a block diagram of an example framework for impression number estimation according to some implementations.

FIG. 2 is a flow diagram of an example process of impression number estimation according to some implementations.

FIG. 3 is a block diagram of an example system architecture for estimating impression numbers according to some implementations.

FIG. 4 is an example table and graph illustrating impression number estimation according to some implementations.

FIG. 5 depicts an illustrative timeline for training an impression estimation model for use in predicting estimated impression ranges according to some implementations.

FIG. 6 is a block diagram illustrating log attributes according to some implementations.

FIG. 7 is a block diagram of an example framework for model training according to some implementations.

FIG. 8 is a flow diagram of an example process for training an impression estimation model according to some implementations.

FIG. 9 is a block diagram illustrating an example of applying a bid value to the model according to some implementations.

FIG. 10 is a block diagram illustrating an example of estimating the range during model training according to some implementations.

FIG. 11 is a block diagram illustrating an example of evaluating the range according to some implementations.

FIG. 12 is a flow diagram of an example process for using the impression estimation model to determine a predicted impression range according to some implementations.

FIG. 13 is a block diagram of an example computing device and environment according to some implementations.

### DETAILED DESCRIPTION

### Estimating Bid Traffic

The technologies described herein generally relate to estimating bid traffic in an advertising service. For example, some implementations pertain to providing estimated impression numbers to aid advertisers in bidding keywords. As mentioned above, in advertisement bidding, various advertisers apply bid values to keywords that the advertisers would like their advertisements to be associated with. The advertising service then selects one or more advertisements for display to a user based on input trigger data, such as a query submitted by a user to a search service. For instance an advertisement may be selected based on both the bid amount and a relevance of the bid keyword/advertisement to the trigger data. Generally, advertisements with high bid amount values and high keyword relevance are more likely to get a higher number of impressions, but the expected number of impressions relative to bid amount can be difficult to predict. Thus, some implementations herein provide an impression estimation component that may accurately provide a range of the predicted number of impressions based on a particular bid amount. For example, some implementations may assist advertisers in setting bid amount values by estimating and presenting expected impression number ranges for different bid values.

Some implementations employ a log of advertisement bidding data (i.e., historical ad records) as training data that may be used to generate and train an impression estimation model. In some implementations, the impression estimation model may be a statistical regression model. After generating and training of the impression estimation model, the impression estimation model may be used to calculate a regression value based on features generated from the log of advertisement bidding data and a proposed bid value. A predicted estimation error (PEE) may be calculated based on the regression value. An estimated impression value range may be provided such that both the upper bound and the lower bound of the impression value range may be determined based on the PEE.

Additionally, during training and/or prediction, one or more evaluation metrics may be used to evaluate the impression value range. Thus, the impression estimation component may further evaluate the impression value range using one or more evaluation metrics such as a precision metric, estimation rate, average estimation error (AEE), and/or average range width (ARW). The evaluation may be used to further refine the impression estimation model. Unlike some estimation systems which estimate impressions to a single value, the impression estimation component herein is able to account for bidding system dynamics and random actions of the advertisers to provide a range of estimated impression values. Thus, the impression estimation component is able to provide accurate information to aid an advertiser in setting a bid amount value for an advertisement-keyword pair.

### Example Framework

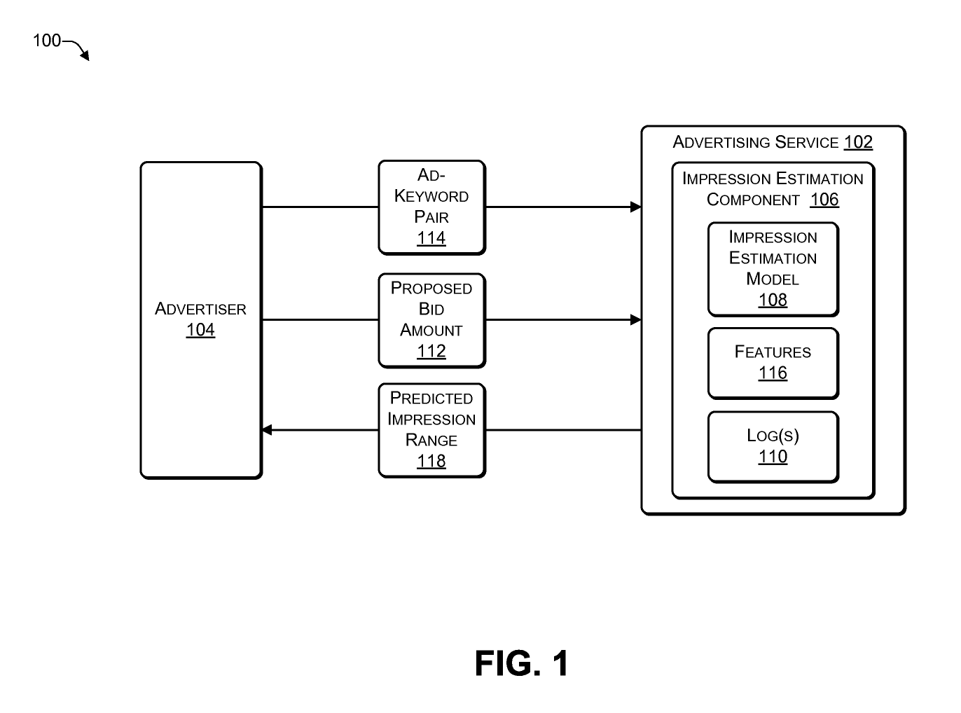

FIG. 1 is a block diagram of an example framework 100 for impression estimation and prediction according to some implementations. Framework 100 includes an advertising service 102 in communication with an advertiser 104. The advertising service 102 may include an impression estimation component 106. The impression estimation component may include an impression estimation model 108 that has been trained using one or more advertisement logs 110. For example, logs 110 may include advertisement bidding records containing results associated with actual advertisement bidding, such as the number of impressions achieved by a particular advertisement for a particular keyword based on a particular bid. According to some implementations, the advertising service 102 may receive a proposed bid amount 112 for an advertisement-keyword pair 114 from advertiser 104. As used herein the term “ad-keyword pair” may refer to a single advertisement or may refer to a group of advertisements (i.e., an ad group) that is paired with a bid keyword. For example, an ad group may include a one or more ads and one or more keywords that the advertiser would like the ads displayed in association with. Thus, depending on a desired implementation, estimated impressions may be predicted for individual ads, for ad groups, or for both.

The impression estimation component 106 may determine a set of features 116 for the ad-keyword pair 114, based on certain attributes obtained from the logs 110, as discussed additionally below. The impression estimation component 106 may apply the features 116 and the proposed bid amount 112 to the impression estimation model 108 to determine a predicted impression range 118. The advertising service 102 may provide this predicted estimation range 118 to the advertiser 104 to enable the advertiser 104 to adjust the proposed bid amount 112 to achieve a desired number of impressions for the ad-keyword pair 114.

As an example, suppose an advertiser had a bid price of $0.80 on an ad-keyword pair. During a first period of time, the ad-keyword pair received 698 impressions. The advertiser may desire to increase the number of impressions and thus may be curious as to how many impressions may be expected if the bid price were increased from $0.80 to $1.59. In response, impression estimation component 106 may apply the proposed bid value (i.e., $1.59) to the impression estimation model, along with features 116 determined for the ad-keyword pair 114 to which the proposed bid 112 pertains. The impression estimation component 106 may further determine features 116 for the ad-keyword pair 114, based on logs 110, and provide these to the impression estimation model 108 as well. Using the trained impression estimation model 108, the impression estimation component 106 calculates the values of the predicted impression range 118 for the proposed bid value 112 and the ad-keyword pair 114.

### Example Process

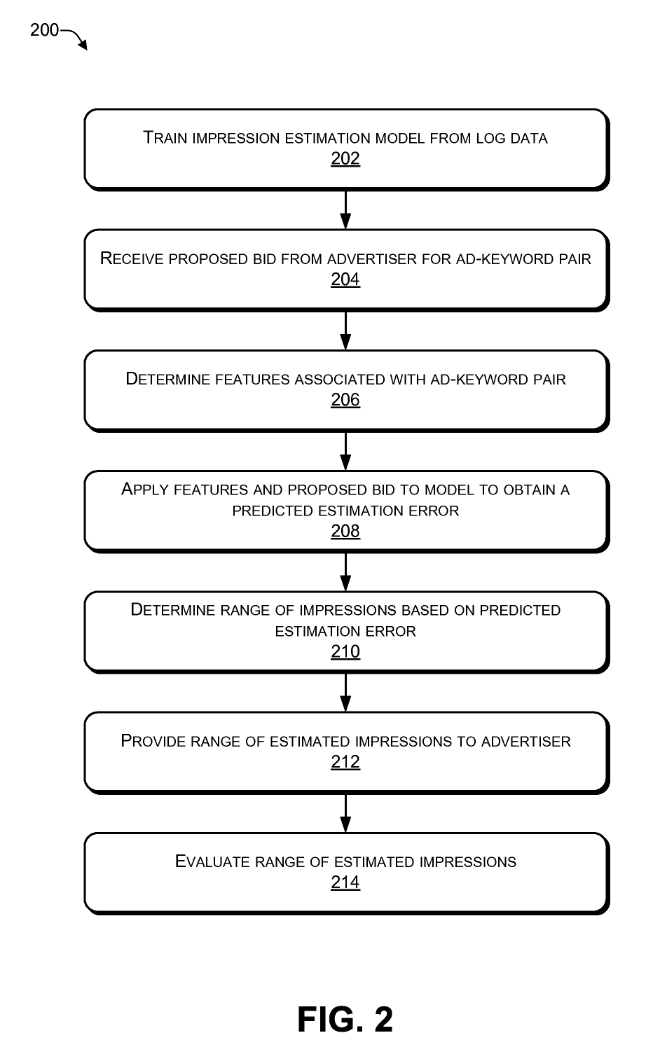

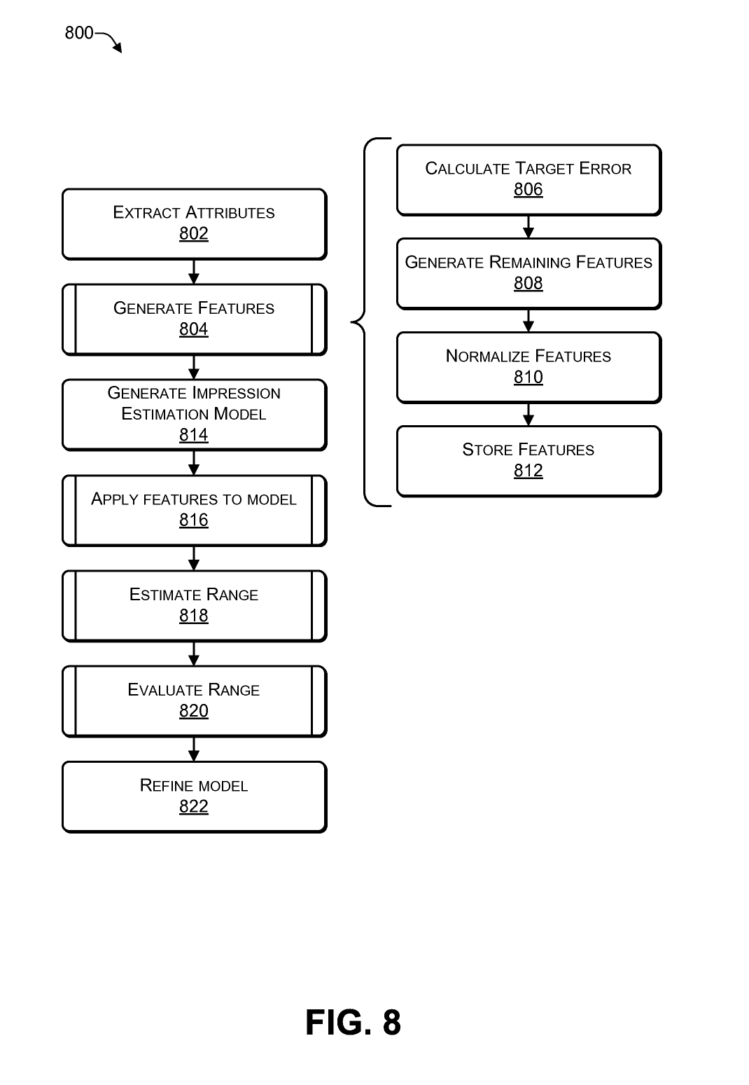

FIG. 2 is a flow diagram of an example process 200 for estimating impression numbers to aid advertisers in bidding keywords according to some implementations herein. In the flow diagram of FIG. 2, and in the flow diagrams of FIGS. 8-12, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, components, data structures, and the like that perform particular functions or implement particular abstract data types. The order in which the blocks are described is not intended to be construed as a limitation, and any number of the described operations can be combined in any order and/or in parallel to implement the process. For discussion purposes, the process 200 is described with reference to the framework 100 of FIG. 1, although other frameworks, devices, systems and environments may implement this process. In some instances, the process may be implemented by a single computing device, multiple computing devices, or combinations of computing devices, as described additionally below.

At block 202, the impression estimation component 106 trains the impression estimation model 108 using historical data from logs 110. For example, a log of advertisement bidding data including both initial training data from a first period of time and test training data from a second period of time may be used to train the impression estimation model 108, as described additionally below. Upon completion of training the model, the trained model may be used for predicting a range of estimated impression values.

At block 204, the impression estimation component receives a proposed bid from an advertiser for an ad-keyword pair.

At block 206, the impression estimation component determines features associated with the ad-keyword pair. For example the impression estimation component may determine features such as a target error (i.e., an estimation error of the estimated impression value), an estimated number of impressions based on data simulation, a real number of impressions obtained in the past over a predetermined training period, a number of auctions during the training period, a sum of auction sizes during the training period, a mean of bids during the training period, and a variance of bids during the training period. In determining the estimated number of impressions based on data simulation, the impression estimation component simulates the bid value based on the proposed bid value and re-runs past auctions from the log files to calculate the estimated number of impressions that would have been achieved during those auctions if the bid for the ad-keyword pair had been at the proposed bid value.

At block 208, the impression estimation component applies the features and proposed bid value to the impression estimation model to determine a predicted estimation error for the proposed bid. In some implementations, the impression estimation component may calculate a regression value from the impression estimation model and may use the regression value to calculate a predicted estimation error.

At block 210, the impression estimation component determines a range of impression values based on the predicted estimation error. For example, the range may correspond to an estimated impression value plus or minus the predicted estimation error.

At block 212, the impression estimation component provides the range of estimated impression values to be advertiser in response to the proposed bid. For example, the advertiser may then submit the bid for auction, or may submit a new proposed bid if the range of the estimated number of impressions does not meet with the expectations of the advertiser.

At block 214, the range of estimated impression values may also be evaluated using one or more evaluation metrics. For example, the precision may be evaluated using a precision metric. Further, the estimation rate may be evaluated using an estimation rate metric. Additionally, the average estimation error and the average range width may be determined. In some implementations, the evaluation results may be applied to refine the model by improving the training of the impression estimation model. For example, the ad-keyword pairs can be assigned to different buckets according to their real numbers of impressions (e.g., [0, 10], [10, 100], [100, 1000], [1000, infinite]). To improve the buckets with low precision scores (or to improve buckets having a high average estimation error or a large average range width), some implementations herein adjust the training data, such as by adding more training data belonging to these buckets, and re-train the impression estimation model using the adjusted or revised training data.

### Example System Architecture

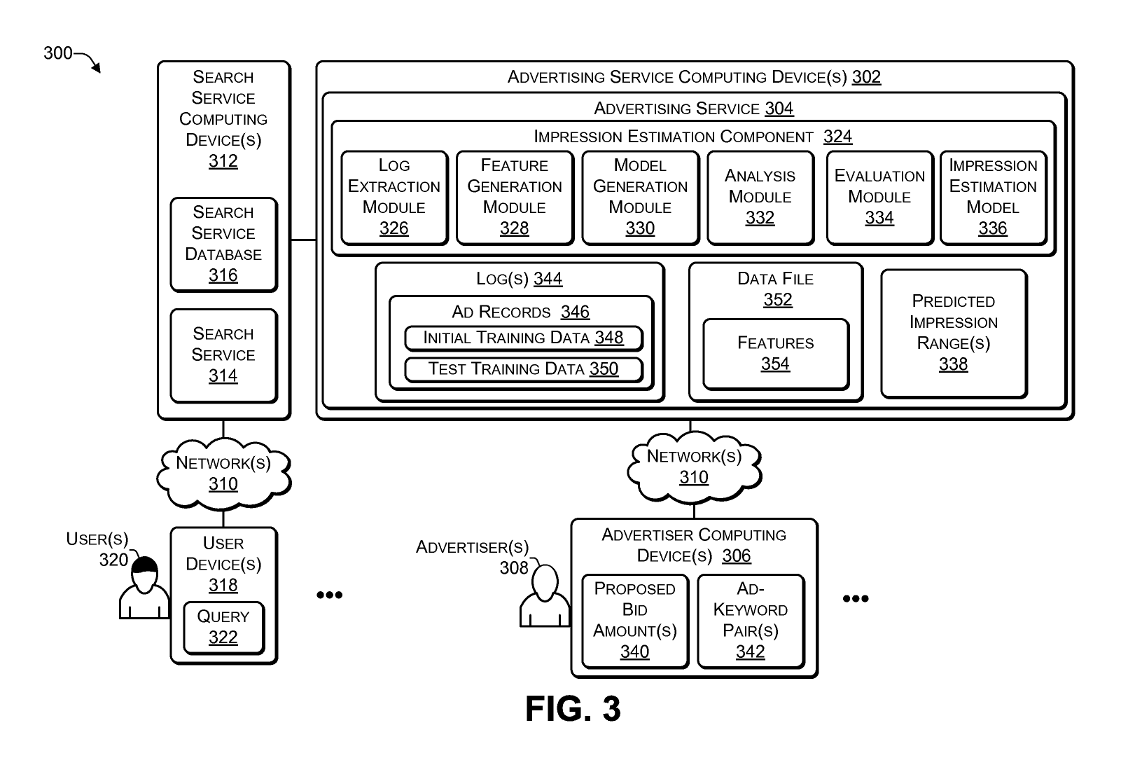

FIG. 3 illustrates an example system architecture 300 for estimating impression numbers and ranges in accordance with various implementations. In some instances, the system architecture 300 may implement the framework 100 of FIG. 1, although other architectures, devices, systems and environments may implement the framework 100. The system architecture 300 may include one or more advertising service computing device(s) 302 configured to provide an advertising service 304 having capability to estimate and predict impression numbers. The advertising service computing device 302 may include any suitable type of computing system such as server computers, personal computers, laptop computers, mainframe computers, distributed computing systems, parallel computing systems, and other types of computing systems and devices. The advertising service computing device 302 may be in communication with one or more advertiser computing devices 306 of one or more advertisers 308 through one or more network(s) 310. Network(s) 310 may include the Internet, a local area network (LAN), a wide area network (WAN), a wireless network, or other suitable communication network, or a combination of networks, enabling communication between advertising service computing device 302 and advertiser computing device 306. Thus, the advertiser 308 may conduct business with and manage advertisements with advertising service 304 through network(s) 310 or through other suitable communication functionalities.

In the illustrated example, the advertising service computing device 302 may also be in communication with one or more search service computing devices 312 that may include a search service 314 and a search service database 316. However, other implementations contemplated herein are not limited to use with a search service. Further, in some implementations, the search service 312 may be implemented on the same computing device(s) as the advertising service 304. For example, the advertising service 304 and the search service 314 may be provided as a unified service implemented by computing devices 302 and 312 at one or more data centers, server farms, or the like. One or more user devices 318 may be in communication with search service 314 through network(s) 310, which may include the same network type as that used for communication between advertiser computing devices 306 and advertising service computing device 302, or a different network type. For example, a user 320 of the user device 318 may submit a search query 322 to search service 314 over network(s) 310. When the search service 314 receives the search query 322, the search service 314 may provide one or more query keywords from the search query 322 to the advertising service 304. In response, the advertising service 304 may identify one or more selected advertisements to be displayed with search results that will be provided in response to the search query 322.

The computing device 302 may include an impression estimation component 324 to aid one or more advertisers 306 in determining what bid values to apply to keywords associated with their advertisements. In general, advertisement bidding is an aspect of the advertisement service 304 that allows advertisers to place bid values on keywords associated with their advertisements. When the search query 322 is received by the search service 314, the search service 314 may provide the query 322 to the advertising service, 304. The advertising service 304 may compare the search query to bid ad-keyword pairs to select one or more advertisements to present along with the search results. For instance, if a query such as “beach vacation” is input to the searching engine, the searching engine may select advertisements to present such as an airline company advertisement associated with the keyword “beach” and/or “vacation” advertising inexpensive flights to areas having beaches.

Typically, advertisements may be selected based on two factors: relevance and bid value. The bid value is the value that the advertiser places on each keyword associated with each advertisement of the advertiser. For instance, the airline company may place a bid value of $0.80 on a keyword of “vacation.” However, advertising service revenue is usually tied not only to impressions, but also to the number of clicks on the impressions. Accordingly, the advertising service does not want to base the advertisement selection decision solely on bid amount because if the advertisements selected are not relevant, then users will generally not click on the advertisements. Thus, relevance may be determined based on a quality score that quantifies a number of factors, such as the similarity between the query, the bid keyword, the advertisement, the advertisement landing page, and the like. Advertisements with high relevance to the query will have a high opportunity to be presented (i.e., impressed). In addition, ad-keyword pairs having a higher bid amount will also have higher opportunity to be impressed, as the advertising service may make more money on such impressions. Thus, ad-keyword pairs having high bid values and high relevance are more likely to get a higher number of impressions.

Advertisers generally desire high impression numbers for an acceptable bid. Accordingly, advertisers may examine the impression numbers they receive over time and adjust their bid values accordingly in order to achieve a desirable impression-to-bid value ratio. In order to help the advertisers adjust their bid values, the advertising service 304 may include an impression estimation component 324 that includes various modules to estimate impression numbers and ranges, such as a log extraction module 326, a feature generation module 328, a model generation module 330, an analysis module 332, and an evaluation module 334. The model generation module 330 may generate an impression estimation model 336 that may be used by the analysis module 334 for calculating predicted impression range(s) 338 in response to proposed bid amount(s) 340 received from an advertiser 308 for ad-keyword pair(s) 342.

The advertising service computing device 302 may additionally include one or more log(s) 344 of historical bidding information. For instance, the logs 344 may include a random subset of ad records 346 sampled from the search service database 316. In some implementations, the logs 344 may include 50,000 or more ad records 346. Each ad record 346 in the logs 344 may contain information of an ad-keyword pair, bid price, number of impressions, number of clicks, etc., collected over a period of time. The ad records 346 may be chronologically separated into two sections: initial training data 348 pertaining to a first period of time and test training data 350 pertaining to a second period of time, subsequent to the first period of time. The initial training data 348 may contain ad records 346 occurring over a first time period of time, such as a first week, first two weeks, or the like. The test training data 350 may contain ad records 346 occurring over a second duration of time, such as a second week, second two weeks, etc. Advertising service computing device 302 may additionally include a data file 352 to store data output from the impression estimation component 324, such as one or more features 354 determined by the feature generation module 328, as described additionally below.

As noted above, the impression estimation component 324 may include various modules to estimate impression numbers and to provide predicted impression ranges 338. For instance, the impression estimation component 324 may include the log extraction module 326 to extract attributes from the logs 344 of advertisement bidding data, the feature generation module 328 to generate features for regression training, the model generation module 330 to generate the impression estimation model 336, the analysis module 332 to calculate a regression value and estimate an impression value range, and an evaluation module 334 to evaluate the impression value range.

### Example Output

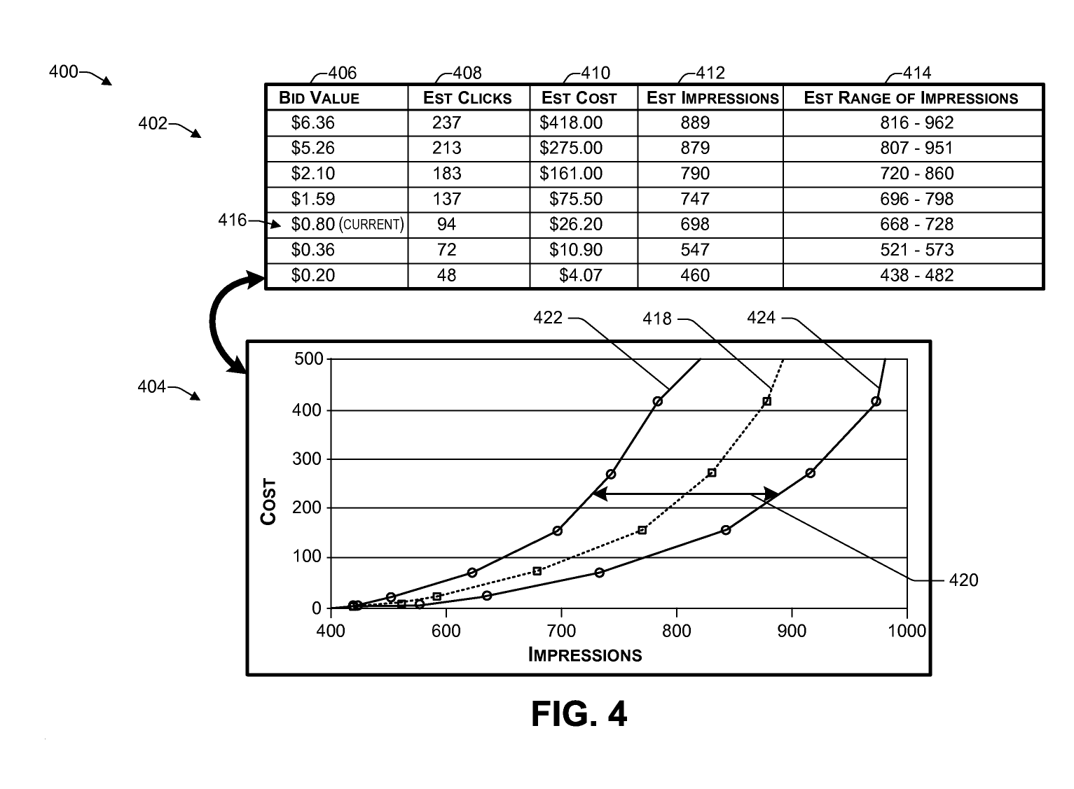

FIG. 4 illustrates an example graphical output 400 of the impression estimation component 324. The example graphical output 400 includes a table 402 and a chart 404. The table 402 may represent bids by an advertiser for a key-word pair, and includes a column for bid value 406, a column for estimated clicks 408, a column for estimated cost 410, a column for estimated impressions 412, and a column for estimated range of impressions 414. As illustrated in the table 402, a current bid value 416 of the advertiser is $0.80. The estimated number of clicks is 94, the estimated cost is $26.20, the estimated number of impressions is 698 based on data simulation, and the estimated range of impressions, as determined according to some implementations herein is 668-728.

Chart 404 illustrates a predicted range of impression values as a function of cost. The dashed curve 418 in the chart 404 shows the estimated impressions, based on data simulation, if the advertiser changes the bid to other quantities. The chart 404 also illustrates an example impression value range 420 that the advertiser may expect if they were to alter their bid value. The impression value range 420 may have a lower bound 422 and an upper bound 424.

In some instances, the data used to generate the table 402 and chart 404 is determined by the impression estimation component 324. For example, suppose that the logs 344 include an ad record 346 indicating that on day 1, an advertiser bid a keyword at price $0.80 for an ad-keyword pair. At the end of the period of time spanning the initial training data 348 (e.g., on day 8 if the period of time is one week), suppose the advertiser checks the system and finds that he received 698 impressions. Now, the advertiser would like to know how many impressions may be expected if the bid is changed from $0.80 to $2.10. First, the impression estimation component 324 may apply a data simulation to the training data 348 of the logs 344 to estimate the impression value to be 790. Next, the impression estimation component 324 may perform a regression analysis using both the initial training data 324 and the test training data 326 of the logs 344 to calculate predicted impression range, e.g., 720-860 in this example. This range may be presented to the advertiser, rather than the estimated impression value of 790, so that the advertiser understands that the actual number of impressions will be likely to fall within the predicted range of 720-860.

Unlike previous estimation systems which estimate impressions to a single value (i.e., the dashed curve 418), the impression estimation component 324 is able to take into account the dynamics of the bidding system and random actions of advertisers to estimate a range of impression values. Thus, the impression estimation component 324 provides more accurate information to aid advertisers in setting bid values for their advertisements.

### Example Timeline

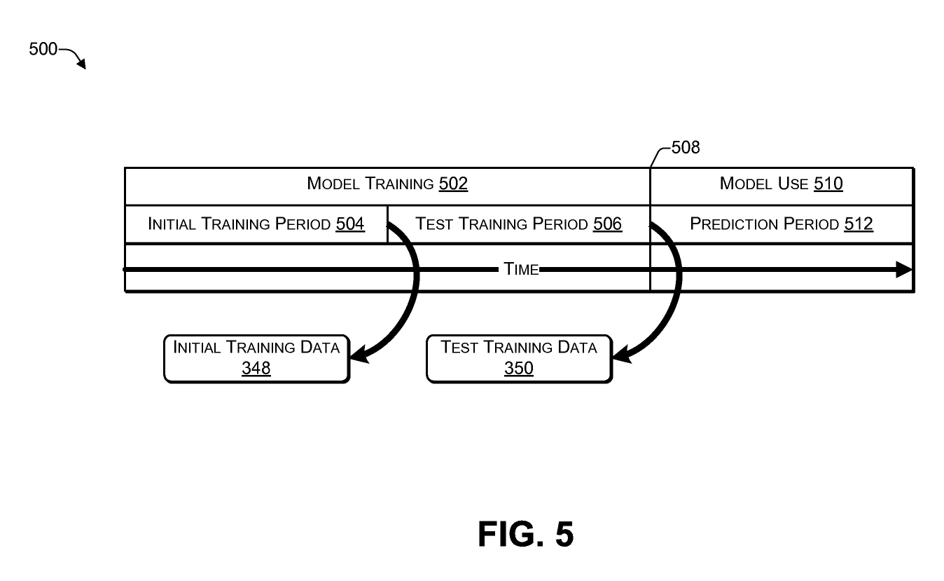

FIG. 5 illustrates an example timeline 500 for training and using the impression estimation model 336 according to some implementations. In this example, model training 502 employs data collected during a first or initial training period 504, and also employs data collected during a second or test training period 506. Following completion of model training 502 at a point in time 508, model use 510 may take place during a prediction period 512. In some implementations, each of the initial training period 504, the test training period 506 and the prediction period 512 may be approximately equivalent time periods for ease of model generation and use. For example, each period 504, 506 and 512 may be approximately the same length, e.g., one week, two weeks, one day, two days, three days, five days, etc. However, in other implementations, one or more of the initial training period 504, the test training period 506 and the predication period 512 may be periods of time of different lengths from the other period of time 504, 506, 512, and the model training 502 and/or model use 510 may take this difference into consideration.

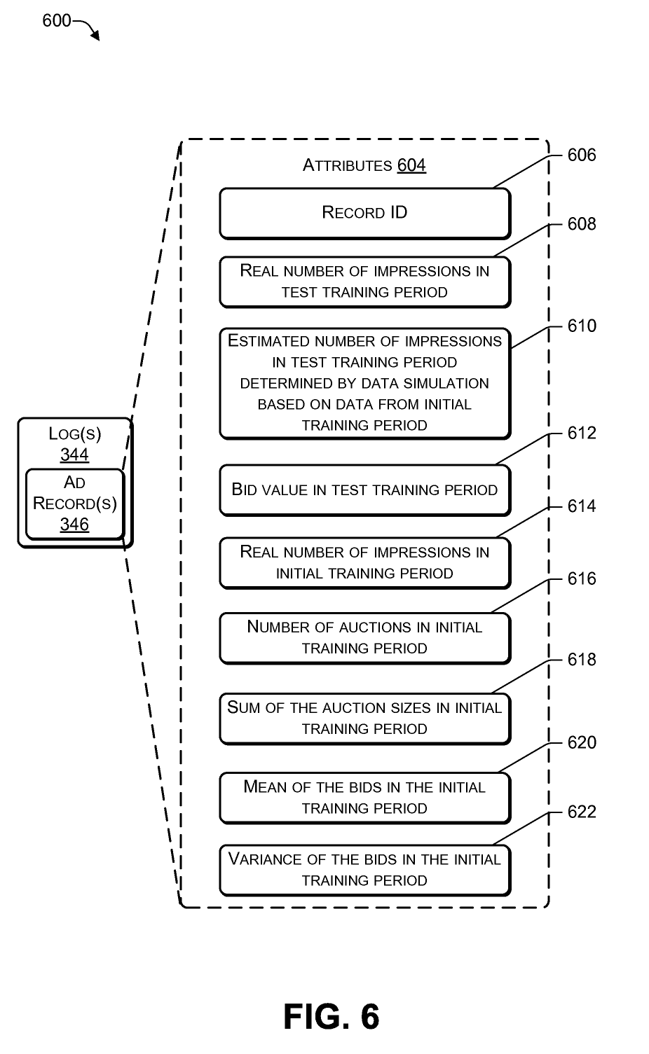

As an example, suppose that initial training period 504 is a first week, test training period 506 is a second week, and the prediction period 512 for which an advertiser would like an estimate of a predicted number of impressions is a third week. Then, during model training 502, a plurality of attributes are extracted from the initial training data 348 collected during the initial training period 504, and several other attributes are determined based on test training data 350 collected during the test training period 506. The attributes from the initial training period 504 and the test training period 506 are used to generate the impression estimation model. Example attributes are described below with reference to FIG. 6. Subsequently, during model use 510, attributes are extracted from the test training period data and applied with the proposed bid amount submitted by the advertiser to determine an estimated range of impression values that correspond to the proposed bid amount for the ad-keyword pair.

### Example Attributes

FIG. 6 is a block diagram 600 that illustrates example attributes 604 that may be generated based at least in part from the records 346 of the logs 344. In some instances, some of the attributes 604 may correspond to some of the features 116, 354 described above. As mentioned above, the logs 344 may include one or more ad record(s) 346 sampled from the search service database 316. Accordingly, attributes 604 may be determined for each ad record 346 for training and modeling purposes. Example attributes 604 may include one or more of a record identifier 606, a real number of impressions 608, an estimated number of impressions 610, a bid price 612 in the test training period, a real number of impressions 614 in the initial training period, a number of auctions 616 in the initial training period, a sum of auction sizes 618 in the initial training period, a mean of the bids 620 in the initial training period, and a variance of the bids 622 in the initial training period.

The record ID 606 may correspond to an identifier for an ad-keyword pair. The real number of impressions 608 may correspond to the actual impression count that the ad-keyword pair received during the test training period 506. The estimated number of impressions 610 may correspond to an estimated impressions count for the ad-keyword pair estimated for the test training period 506 based on data simulation using data from the initial training period 504 and the bid price 612 in the test training period. The bid price 612 in the test training period may correspond to the bid price on the ad-keyword pair during the test training period 506. The real number of impressions 614 in the initial training period may correspond to an actual impression count that the ad-keyword pair received during the initial training period 504. The number of auctions 616 in the initial training period may correspond to the number of auctions that actually took place for the ad-keyword pair during the initial training period 504. The sum of auction sizes 618 in the initial training period may correspond to a sum of all the auction sizes (i.e., number of ad-keyword pairs participating in the auction) during the initial training period 504. The mean of the bids 620 in the initial training period may correspond to the mean of the bid values for the ad-keyword pair in the initial training period 504. The variance of the bids 622 in the initial training period may correspond to the variance of the bid values during the initial training period 504. In some implementations, the log extraction module 326 may extract one or more of the attributes 604 from the ad records 346 contained in the logs 344.

### Example Framework for Model Training

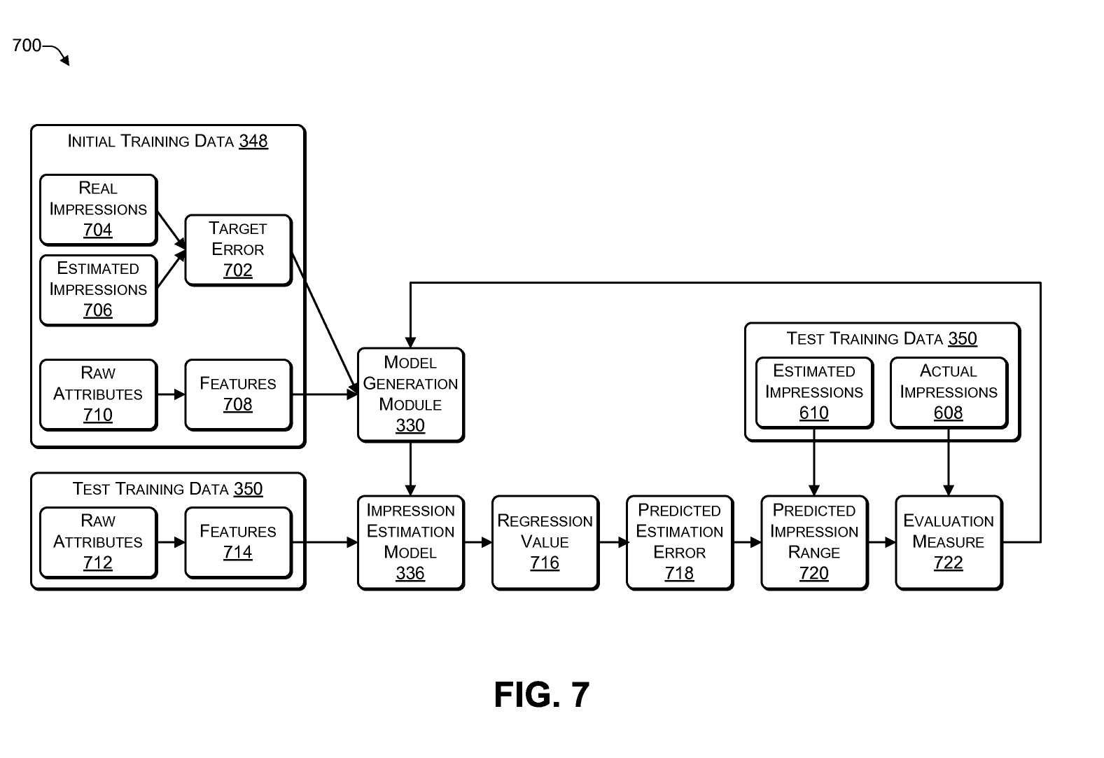

FIG. 7 is a block diagram illustrating an example framework 700 for generating and training the impression estimation model 336 according to some implementations. In some instances, the framework 700 may be implemented by the system architecture 300 of FIG. 3, although other architectures, devices, and environments may implement this framework. In the framework 700, initial training data 348 collected during the initial training period 504 may be extracted by log extraction module 326. For an extracted record 346, a target error 702 may be determined from a real number of impressions 704 and an estimated number of impressions 706. The real number of impressions is the number of impressions that were recorded for the record during the initial training period 504. The estimated number of impressions is the estimated number of impressions predicted for the test training period 506 based on data simulation carried out using data of the initial training period and the bid amount for the test training period. Thus, the target error value may be formulated as shown in equation (1) as follows:

$$Target\_Error Value = \frac{\vert Real\_Imp - Est\_Imp \vert}{Est\_Imp} \qquad ( 1 )$$

in which Real_Imp corresponds to the real number of impressions 608 recorded during the test training period and Est_Imp is estimated number of impressions 610 estimated for the test training period by using data simulation based on the data of the initial training period. For a particular record, if the target error is greater than one, then the record is discarded from the set of training data. Typically, about 5-10% of records may be discarded based on this rule.

In addition to the target error, additional features 708 may be generated from raw attributes 710 of the records of the initial training data 348 by the feature generation module 328. These features 708 may include the estimated impressions 610 based on data simulation, the real number of impressions 614, the number of auctions 616, the sum of auction sizes 618, the mean of the bids 620 and the variance of the bids 622, as described above. Thus a first portion of the features 354 are generated from attributes obtained from the initial training period. The target error 702, as a first feature, and the other features 708 may be provided by the feature generation module 328 to the model generation module 330. The features 708 correspond to some of the attributes 604 described above, and, in particular, attributes 614-622 in some implementations. Further, the features 708 may be normalized, as described below, prior to being applied to the model. The model generation module 330 may generate the impression estimation model 336 using adaptive boost regression model training, as described additionally below.

Further, raw attributes 712 of the test training data 350 collected during the test training period 506 may also have features 714 extracted and applied to the estimation model 336 during training. Thus, a second portion of the features 354 are obtained from the test training period 506. The features 714 may include the real number of impressions 608 during the test training period and the bid price 612 during the test training period. During the training of the impression estimation model 336, based on the initial training data 348 and the test training data 350, a regression value 716 is obtained as output from the impression estimation model 336. Based on the regression value 716, a predicted estimation error 718 may be determined. From the predicted estimation error 718 and the estimated number of impressions 610 in the training test period, determined based on data simulation from data in the initial training period, the predicted impression range 720 may be determined. When the predicted estimation range 720 has been determined for the test training period, the predicted estimation range for the test training period may be compared with the actual number of impressions 608 for the test training period as an evaluation measure 722 using one or more evaluation metrics for determining precision, estimation rate, average estimation error, or average range width. The results of the evaluation measure 722 may be provided to the model generation module 330 to refine the impression estimation model.

### Example Process for Model Generation

FIG. 8 is a flow diagram of an example process 800 for generating and training an impression estimation model according to some implementations herein. For discussion purposes, the process 800 is described with reference to the system architecture 300 of FIG. 3, although other architectures, devices and environments may implement this process. In some instances, the process 800 may be implemented by the advertising service computing device(s) 302, one or more other computing devices, or any combination thereof.

At block 802, the log extraction module 326 extracts attributes from a log such as the logs 344 of FIG. 3. In some instance, the log extraction module 326 may extract one or more of the attributes 604 from the logs 344. For instance, for a plurality of records 346, the log extraction module 326 may extract one or more of the record ID 606, real number of impressions 608 during the test training period, the estimated impressions 610 during the test training period, the bid value 612 during the test training period, the real number of impressions 614 during the initial training period, the number of auctions 616, the sum of auction sizes 618, the mean of the bids 620, and the variance of the bids 622.

At block 804, the feature generation module 328 generates features 354 for regression training. The features 354 may be generated from the attributes 604 extracted from the logs 344, as described in block 802, and may include a target error value 702, features 708 and features 714, as described above. Generating the features 354 at block 804 may include calculating the target error at block 806, generating the remaining features 708 and 714 at block 808, normalizing the remaining features at block 810, and storing the features to a data file at block 812, the detail each of which are described below.

At block 806, the target error value 702 may be calculated as described above using equation (1) in which Real_Imp corresponds to the real number of impressions 608 recorded during the test training period and Est_Imp is the estimated number of impressions 610 estimated for the test training period by using data simulation based on the data of the initial training period. In some instances, if the target error value is greater than one, then the corresponding record may be discarded from the ad records 344 being used as training data. The target error value corresponds to an estimation error of the estimated impression value 610 estimated using data simulation. As discussed above, data simulation involves simulating historical auctions for an ad-keyword pair using a modified bid value, e.g., the bid price 612 in the test training period.

At block 808, the remaining features (i.e., record ID 606, real number of impressions during test period 608, estimated impressions during test period 610, bid value during test period 612, real number of impressions during initial training period 614, number of auctions 616, sum of auction sizes 618, mean of the bids 620, and/or the variance of the bids 622) may be generated from the corresponding raw attributes of the logs 344.

At block 810, in some instances, the features 354 may be normalized (i.e., real number of impressions during test period 608, estimated impressions during test period 610, bid value during test period 612, real number of impressions during initial training period 614, number of auctions 616, sum of auction sizes 618, mean of the bids 620, and/or the variance of the bids 622). For instance, for each of these features, all of the records 346 in the logs 344 are sorted based on the feature value. Next, a CutValue for the feature is calculated, such that 95% of the records have a feature value smaller than or equal to CutValue, and the remaining 5% of the records have a feature value larger than CutValue. Following establishing the CutValue, for the 5% of the records that have feature values larger than the CutValue, the feature value is set equal to the CutValue. Subsequently, all of the feature values are divided by the CutValue so that the feature is normalized to the interval [0, 1]. This normalization may be performed for some or all of the following features: real number of impressions during test period 608, estimated impressions during test period 610, bid value during test period 612, real number of impressions during initial training period 614, number of auctions 616, sum of auction sizes 618, mean of the bids 620, and/or the variance of the bids 622

At block 812, the features 354 (i.e., the target error value and the remaining features, namely, record ID 606, real number of impressions during test period 608, estimated impressions during test period 610, bid value during test period 612, real number of impressions during initial training period 614, number of auctions 616, sum of auction sizes 618, mean of the bids 620, and/or the variance of the bids 622) for all of the processed records 346 are stored. In some instances, the features 354 may be stored to the data file 352 of FIG. 3. The CutValues for each of the features 608-622 may additionally be stored to the data file 352.

At block 814, the model generation module 330 generates the impression estimation model 336. In some instances, an adaptive boosting (“AdaBoost”) regression technique may be used to generate the impression estimation model 336. The AdaBoost Algorithm is a machine learning algorithm that can be used in conjunction with other learning algorithms to improve performance. Some implementations herein use the AdaBoost Algorithm in conjunction with statistical regression to generate and apply the impression estimation model herein. For example, let xᵢεR^{K} denote the K-dimensional feature vector of the i-th instance, and yᵢεR denote the ground truth value of the i-th instance. Then, given a set of training instances (xᵢ, yᵢ), i=1, 2, . . . , n, the process will learn a function h(x), which can map the feature vector to its ground truth value. That is, the process minimizes the following loss:

$$min {\sum }_{i} {( {y}_{i} - h ( {x}_{i} ) )}^{2} . \qquad ( 2 )$$

Without loss of generality, some implementation may use the square loss.

The AdaBoost Algorithm may be implemented using as input a set of training instances (x₁, y₁), (x₂, y₂), . . . , (xₙ, yₙ), a set G of candidate functions, and the number of rounds T. The output of the AdaBoost Algorithm is a final decision function:

$$h ( x ) = {\sum }_{t} {α}_{t} {h}_{t} ( x ) \qquad ( 3 )$$

Statistical regression may be applied using the AdaBoost Algorithm. The basic idea of the AdaBoost Algorithm is to linearly combine a set of weak classifier/function to get a final strong function:

$$h ( x ) = {\sum }_{t} {α}_{t} {h}_{t ( x )} \qquad ( 4 )$$

AdaBoost searches for an optimal weak function repeatedly in a serials of rounds t=1, 2, . . . , T. In each round, a best function is determined from a set G of candidate functions. For example, consider the t-th round. Then for each candidate function gεG, an optimal weight is calculated by minimizing its loss as follows:

$$L ( α , g ) = {\sum }_{i} {( {y}_{i}^{t - 1} - ag ( {x}_{i} ) )}^{2} \qquad ( 5 )$$

By setting the derivative of L(α, g) with respect to α to 0, the following is obtained:

$$\frac{\partial L ( α , g )}{\partial α} = - 2 {\sum }_{i} g ( {x}_{i} ) ( {y}_{i}^{t - 1} - ag ( {x}_{i} ) ) = 0 \qquad ( 6 )$$

Then, α may be characterized as follows:

$$α = \frac{{\sum }_{i} g ( {x}_{i} ) {y}_{i}^{t - 1}}{{\sum }_{i} {g}^{2} ( {x}_{i} )} \qquad ( 7 )$$

To implement the AdaBoost Algorithm with regression, a set of candidate functions is selected. Implementations herein may convert each feature as a set of weak functions. Suppose that there are K features, and a set of M thresholds {th_{k,1}, th_{k,2}, . . . , th_{k,M}} is given for each feature k. Then it is possible to derive M binary weak functions for the k-th feature:

$${g}_{k m} ( {x}_{i} ) = \{ \begin{matrix}1 , & if {x}_{i , k} \geq {th}_{k , m} \\ 0 , & otherwise\end{matrix} \qquad ( 8 )$$

Doing so enables determination of M×K candidate functions in total. Thus, implementations may apply AdaBoost to produce a regression model that may be used as the impression estimation model 336 herein. Training of the model may be accomplished based on instructions in the following pseudocode:
Initialize h₀(xᵢ)=0, yᵢ⁰(xᵢ)=yᵢ for each training instance;
For t=1 to T:
   For each training instance, update:

yᵢ^{t}=tᵢ^{t-1}−αₜ₋₁hₜ₋₁(xᵢ); (9)
For each candidate function gεG:
   Compute its optimal weight α according to Eq (7);
   Compute its loss (with the above optimal weight) according to Eq (5);
End
Set hₜ to be the candidate function with the smallest loss (among all the candidate functions) and set αₜ to be the optimal weight associated with the candidate function.

Additional details of applying AdaBoost in regression applications are provided in a paper written by Greg Ridgeway, David Madigan, and Thomas Richardson, entitled “Boosting Methodology for Regression Problems,” In Proc. of the 7th International Workshop on Artificial Intelligence and Statistics (pp. 152-161) 1999.

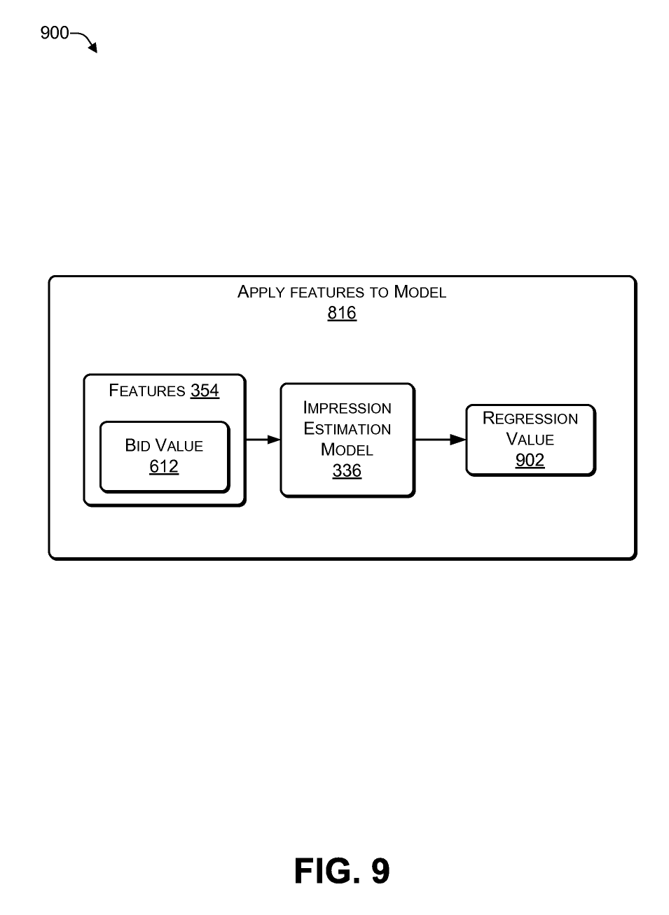

At block 816, the analysis module 332 applies the features 354, including the features for the test training period, to the impression estimation model 336, as further illustrated in FIG. 9. The analysis module uses the impression estimation model 336 to calculate a regression value (i.e., regression value 716) as an output of the impression estimation model 336.

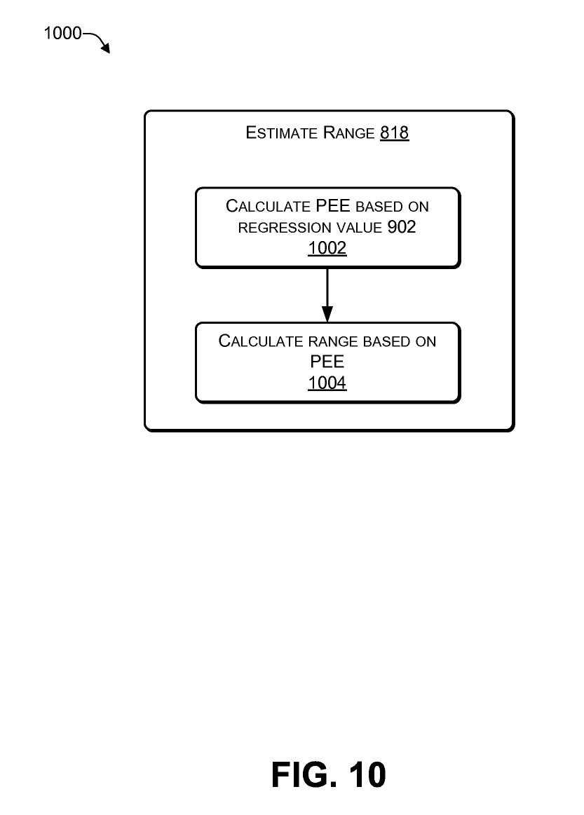

At block 818, the analysis module 332 predicts the impression value range. Estimating the impression value range may include calculating the impression value range based on a predicted estimation error 718 determined for the regression value 716 output by the impression estimation model 336. FIG. 10 illustrates additional details of predicting the impression value range.

At block 820, the evaluation module 334 evaluates the impression value range determined in block 818. Evaluating the impression value range 416 may include applying one or more evaluation metrics, such a precision metric, estimation rate, average estimation error (AEE), and/or average range width (ARW) as further illustrated in FIG. 6.

At block 822, the results of the evaluation may be applied to improve the training of the model and to thereby refine the impression estimation model. For example, the ad-keyword pairs can be assigned to different buckets according to their real numbers of impressions (e.g., [0, 10], [10, 100], [100, 1000], [1000, infinite]). To improve the buckets with low precision scores (or to improve buckets having a high average estimation error or a large average range width), some implementations herein adjust the training data, such as by adding more training data belonging to these buckets, and re-train the impression estimation model using the adjusted or revised training data.

FIG. 9 is a flow diagram 900 that illustrates additional details of the operations of block 816 of FIG. 8. In block 816, the analysis module 332 applies the features 354, including the features for the test training period, to the impression estimation model 336. The analysis module 332 uses the impression estimation model 336 to calculate a regression value 716 based on the input features 354. For instance, the features 354 (i.e., the target error value 702, estimated impressions during test period 610, bid value during test period 612, real number of impressions during initial training period 614, number of auctions 616, sum of auction sizes 618, mean of the bids 620, and the variance of the bids 622) of the data file 328 may be input to the impression estimation model 336 to obtain the regression value.

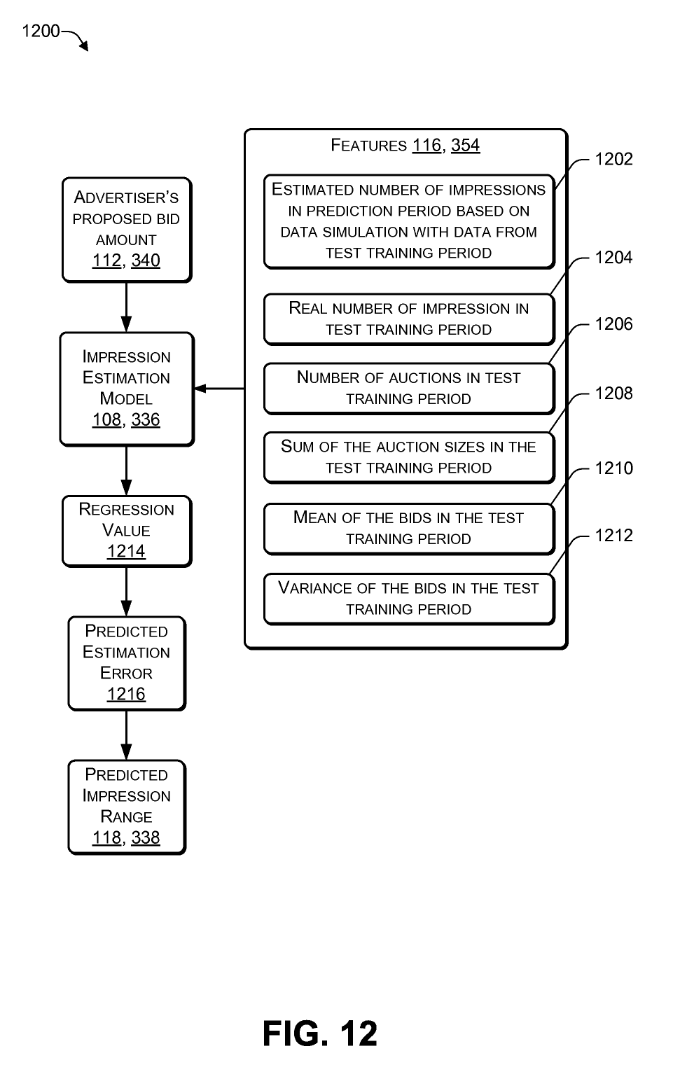

Further, the bid value 612 may be adjusted to various different values to obtain various different regression values, each corresponding to different predicted number of impressions. Accordingly, after training of the model 336 is complete, during the prediction period 512, the bid value 612 may contain an advertiser's proposed bid value, as described additionally below with reference to FIG. 12.

FIG. 10 is a flow diagram 1000 that illustrates additional details of the operations of block 818 of FIG. 8. In block 818, the analysis module 332 may estimate the estimating the range of impression values based on the regression value 716 determined in block 816.

At block 1002, the analysis module 332 calculates a predicted estimation error (i.e., PEE 718) based on the regression value 716. The PEE may be calculated as shown in equation (10) as follows:

$$PEE = \{ \begin{matrix}0 , & Reg\_Value < 0 \\ Reg\_Value & Other \\ 1 , & Reg\_Value > 1\end{matrix} \qquad ( 10 )$$

in which Reg_Value is the regression value 716 calculated at block 816 of FIG. 8.

At block 1004, the analysis module 332 calculates the impression value range 720. The impression value range 720 may be calculated as shown in equation (11) as follows:

Impression Value Range=[left,right] (11)

in which left=[Est_Imp×(1−PEE)] and right=[Est_Imp×(1+PEE)] where Est_Imp is the estimated impressions 610 generated by data simulation based on reenacting auctions that took place during the initial training period with the bid value from the test training period, as generated, e.g., at block 804 of FIG. 8.

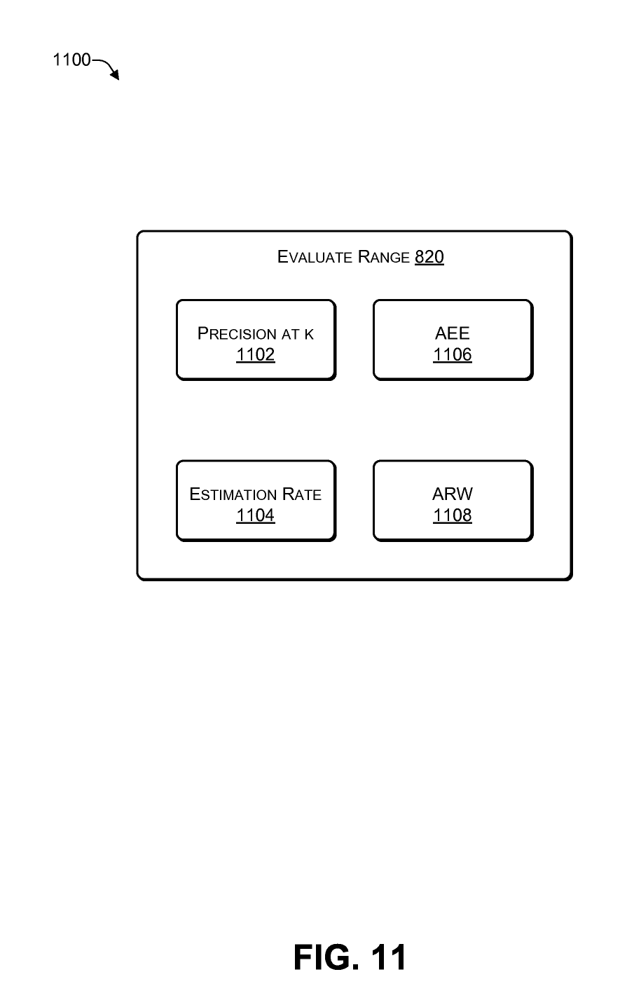

FIG. 11 is a flow diagram 1100 that illustrates additional details of the operations of block 820 of FIG. 8. The elements of FIG. 11 may be performed by the evaluation module 334 and may further describe the evaluating of the impression value range 720 obtained in block 818. The evaluation module 334 may use any suitable evaluation metric to evaluate the accuracy of the predicted impression value range 720. According to some implementations, evaluation metrics include a precision metric determined at block 1102, an estimation rate metric determined at block 1104, an average estimation error (AEE) metric determined at block 1106, and/or an average range width (ARW) metric determined at block 1108.

At block 1102, the evaluation module 334 calculates the precision metric at any value within the predicted impression value range 720, to determine precision at k, as shown in equation (12) as follows:

$$Precision at k = \frac{\vert Real\_Imp ε Impression value range \vert}{\vert Records with PEE \leq k \vert} \qquad ( 12 )$$

in which (0%≦k≦100%), “Real_Imp” is the real number of impressions 608 determined during the test training period. For example, the real number of impressions 608 during the test training period may be generated at block 804 of FIG. 8, and the impression value range 720 may be calculated as described above in equation (11). “Records with PEE≦k” are records of the logs 344 that have a PEE calculated as shown in equation (10) less than or equal to k.

At block 604, the evaluation module 334 calculates an estimation rate, as shown in equation (13) as follows:

$$EstimationRate = \frac{\vert Records with estimated ranges \vert}{\vert Records \vert} \qquad ( 13 )$$

in which “records with estimated ranges” are the number of records in the logs 344 that have estimated ranges and records are the number of records in the logs 344.

At block 606, the evaluation module 334 calculates an average estimation error (AEE), as shown in equation (14) as follows:

$$AEE = \frac{{\sum }_{i ε s} {PEE}_{i}}{\vert S \vert} \qquad ( 14 )$$

in which S is the number of records with estimated ranges and PEE, is calculated as shown in equation (10).

At block 608, the evaluation module 334 calculates an average range width (ARW), as shown in equation (15) as follows:

$$ARW = \frac{{\sum }_{i ε s} ( {right}_{i} - {left}_{i} )}{\vert S \vert} \qquad ( 15 )$$

in which S is the number of records with estimated ranges, and right, and left, are calculated as shown in equation (11).

### Example Process of Using Model

FIG. 12 is a flow diagram 1200 illustrating use of the impression estimation model 108 or 336 during the prediction period 512. Thus, during model use 510, the advertiser's proposed bid amount 112 or 340 is received, e.g., as described above at block 204 of FIG. 2. The features 116 or 354 that are input into the impression estimation model 108 or 336, respectively, correspond to the attributes 610 and 614-622, but during model use 510, are taken from the test training period 506, rather than the initial training period 504. For example, the features 116 or 354 that are input include estimated number of impressions 1202 during the prediction period, as determined from data simulation using the proposed bid amount and data simulation with data taken from the test training period 506. Features 116 or 354 also may include the real number of impressions 1204 during the test training period, the number of auctions 1206 during the test training period, the sum of auction sizes 1208 during the test training period, the mean of the bids 1210 during the test training period, and the variance of the bids 1212 during the test training period. These features are input to the impression estimation model 108 or 336, along with the advertiser's proposed bid amount value 112 or 340, respectively, to calculate the predicted range of impressions 118 or 338, respectively. Thus, based on the inputs, a regression value 1214 is determined. Based on the regression value 1214, a predicted estimation error 1216 is calculated using equation (10). The predicted impression range 118 or 338 is then calculated based on the predicted estimation error 1216 using equation (11). Additionally, in some implementation, the predicted impression range 118, 338 may be evaluated, as described above with reference to FIG. 11.

### Example Computing Device and Environment

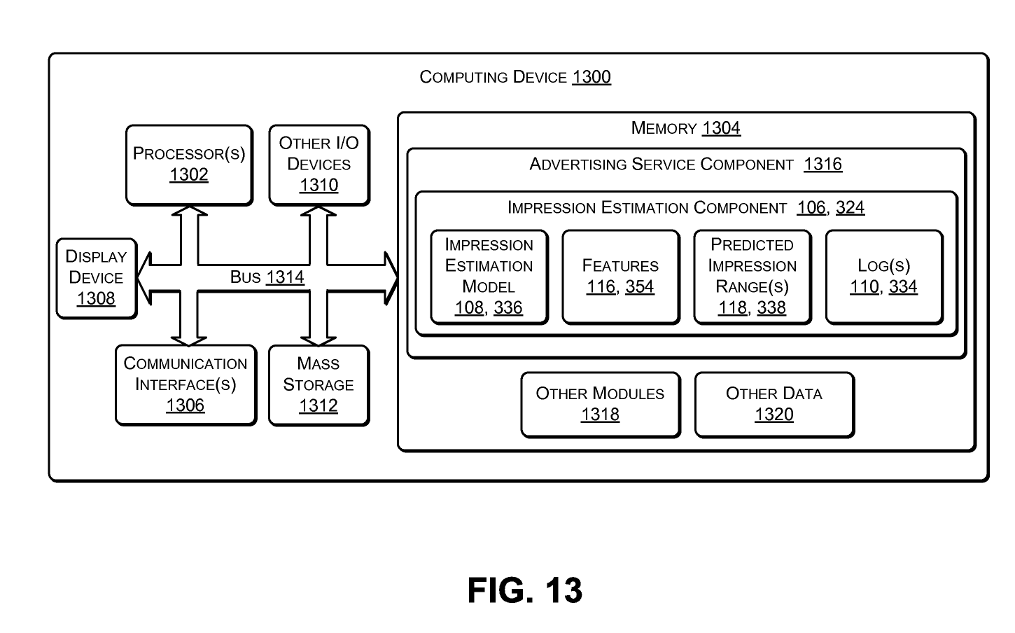

FIG. 13 is a block diagram illustrating select elements of an example configuration of a computing device 1300 that can be used to implement the components and functions for predicting impression ranges as described herein, such as for implementing the impression estimation component 106 and/or 324, as described above. In some implementations, the computing device 1300 may implement the advertising service 102 described above with reference to FIG. 1 and/or the advertising service 304 described above with reference to FIG. 3. Thus, in some implementations, computing device 1300 may correspond to the advertising service computing device(s) 302. The computing device 1300 may include at least one processor 1302, a memory 1304, communication interfaces 1306, a display device 1308, other input/output (I/O) devices 1310, and one or more mass storage devices 1312, able to communicate with each other, such as through a system bus 1314 or other suitable connection.

The processor 1302 may be a single processing unit or a number of processing units, all of which may include single or multiple computing units or multiple cores. The processor 1302 can be implemented as one or more microprocessors, microcomputers, microcontrollers, digital signal processors, central processing units, state machines, logic circuitries, and/or any devices that manipulate signals based on operational instructions. Among other capabilities, the processor 1302 can be configured to fetch and execute computer-readable instructions or processor-accessible instructions stored in the memory 1304, mass storage devices 1312, or other computer-readable storage media.

The computing device 1300 may also include one or more communication interfaces 1306 for exchanging data with other devices, such as via a network, direct connection, or the like, as discussed above. The communication interfaces 1306 can facilitate communications within a wide variety of networks and protocol types, including wired networks (e.g., LAN, cable, etc.) and wireless networks (e.g., WLAN, cellular, satellite, etc.), the Internet and the like. Communication interfaces 1306 can also provide communication with external storage (not shown), such as a storage array, a network attached storage, a storage area network, or the like.

Display device 1308, such as a monitor, may be included in some implementations for displaying information to users. Other I/O devices 1310 may include devices that receive various inputs from a user and provide various outputs to the user, and can include a keyboard, a remote controller, a mouse, a printer, audio input/output devices, and so forth.

Memory 1304 and mass storage devices 1312 are examples of computer-readable media for storing instructions which are executed by the processor 1302 to perform the various functions described above. For example, memory 1304 may generally include both volatile memory and non-volatile memory (e.g., RAM, ROM, or the like). Further, mass storage devices 1312 may generally include hard disk drives, solid-state drives, removable media, including external and removable drives, memory cards, Flash memory, floppy disks, optical disks (e.g., CD, DVD), a storage array, a network attached storage, a storage area network, or the like. Both memory 1304 and mass storage devices 1312 may be non-transitory computer storage media, and may collectively be referred to as memory or computer-readable media herein.

Memory 1304 and/or mass storage 1312 are capable of storing computer-readable, processor-executable instructions as computer program code that can be executed by the processor 1302 as a particular machine configured for carrying out the operations and functions described in the implementations herein. For example, memory 1304 may include modules and components for determining predicted impression ranges according to the implementations herein. In the illustrated example, memory 1304 may include an advertising service component 1316 that may implement either or both of advertising services 102 or 302 described above, affording functionality for calculating predicted impression ranges 118 or 338, respectively. For example, advertising service component 1316 may include impression estimation component 106, 324, which may include impression estimation model 108, 336, features 116, 354, and/or logs 110, 334, and other modules, components and data, as described herein. For example, memory 1304 may also include one or more other modules 1318, such as the log extraction module 326, the feature generation module 328, the model generation module 330, the analysis module 332, and the evaluation modules 336. Other modules 1318 may also include an operating system, drivers, communication software, or the like. Memory 1304 may also include other data 1320 to carry out the functions described above, such as data file 352. Further, while the impression estimation component 106, 324 has been illustrated and described herein in the environment of an advertising service, other implementations of the impression estimation component 106, 324 are not limited to use with an advertising service.

Although illustrated in FIG. 13 as being stored in memory 1304 of computing device 1300, advertising service component 1316, or portions thereof, may be implemented using any form of computer-readable media that is accessible by computing device 1300. Computer-readable media includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
under control of one or more processors configured with executable instructions,
receiving a proposed bid value for an ad-keyword pair;
extracting attributes from a log of advertisement bidding data and resulting impressions accumulated over a period of time;
generating features based on the attributes;
applying the features and the proposed bid value to an impression estimation model; and
determining an impression value range for the proposed bid value based on an output of the impression estimation model.

2. The method as recited in claim 1, wherein the generating the features based on the attributes further comprises calculating a target error value based on an actual impression count that the ad-keyword pair received during the period of time and an estimated impressions count determined for the ad-keyword pair based on data simulation for the proposed bid value.

3. The method as recited in claim 1, wherein the output of the impression estimation model is a regression value.

4. The method as recited in claim 3, wherein the determining the impression value range includes calculating a predicted estimation error (PEE), the PEE being zero when the regression value is less than zero, the PEE being one when the regression value is greater than one, and the PEE being equal to the regression value when the regression value is between zero and one inclusive.

5. The method as recited in claim 4, wherein the determining the impression value range includes calculating the impression value range, wherein an upper bound of the impression value range and a lower bound of the impression value range are both based on the PEE.

6. The method as recited in claim 1, further comprising evaluating the impression value range by calculating one or more of: a precision metric; an estimation rate; an average estimation error; or an average range width.

7. The method as recited in claim 1, further comprising generating the impression estimation model using an adaptive boost regression method.

8. The method as recited in claim 1, further comprising generating the impression estimation model based on an initial training period and a subsequent test training period, wherein log data from the initial training period is used to establish a first set of features for training the impression estimation model and log data from the test training period is used to establish a second set of features for training the impression estimation model.

9. A system comprising:
one or more processors in operable communication with computer-readable media;
a model generation module executed on the one or more processors to perform operations comprising:
generate an impression estimation model based on features generated from a log of advertisement bidding data and a proposed bid value, the log of advertisement bidding data including ad records and resulting impressions occurring over a first period of time and a subsequent second period of time; and
training the impression estimation model using the features generated from the first period of time and the subsequent second period of time.

10. The system as recited in claim 9, further comprising a log extraction module to extract attributes from the log of advertisement bidding data, the attributes including one or more of:
an actual impression count the ad-keyword pair received during the second period of time; and
an estimated impression count of the ad-keyword pair estimated for the second period of time based on log data from the first period of time.

11. The system as recited in claim 10, the attributes further including one or more of:
an identifier of an ad-keyword pair;
an actual impression count that the ad-keyword pair received during the first period of time;
a number of auctions during the first period of time;
a sum of auction sizes during the first period of time;
a mean of the bids during the first period of time; or
a variance of the bids during the first period of time.

12. The system as recited in claim 10, further comprising a feature generation module to generate a target error value to use in generating the impression estimation model, the target error value being determined based on the actual impression count that the ad-keyword pair received during the second period of time and the estimated impression count of the ad-keyword pair estimated for the second period of time based on log data from the first period of time.

13. The system as recited in claim 9, the operations further comprising an analysis module to:
determine a regression value from the impression estimation model; and
calculate a predicted range of impression values for the proposed bid value based on the regression value.

14. The system as recited in claim 13, wherein:
the analysis module is configured to calculate the predicted range of impression values based on a predicted estimation error; and
the predicted estimation error is zero when the regression value is less than zero, the predicted estimation error is one when the regression value is greater than one, and the predicted estimation error is the regression value when the regression value is between zero and one inclusive.

15. The system as recited in claim 13, further comprising an evaluation module to evaluate the predicted range of impression values by calculating one or more of: a precision metric; an estimation rate; an average estimation error; or an average range width, the evaluation module adjusting the training data based on evaluation results to re-train and refine the impression estimation model.

16. The system as recited in claim 9, wherein the impression estimation model is generated based on adaptive boost regression.

17. One or more computer-readable media having instructions stored thereon executable by a processor to perform operations comprising:
extracting attributes from a log of advertisement bidding data, the including initial training data of ad records occurring over a first period of time and test training data of ad records occurring over a second period of time;
generating features based on the attributes;
applying the features and a proposed bid value of an ad-keyword pair to an impression estimation model to determine a regression value; and
predicting an impression value range for the proposed bid value based on the regression value.

18. The one or more computer-readable media as recited in claim 17, the operations further comprising generating the impression estimation model using an adaptive boost regression method for training the impression estimation model based on the features, wherein a first portion of the features are from the first period of time and a second portion of the features are from the second period of time.

19. The one or more computer-readable media as recited in claim 15, wherein predicting the impression value range includes calculating the impression value range, wherein an upper bound of the impression value range and a lower bound of the impression value range are both based on a predicted estimation error determined based on the regression value.

20. The computer readable media of claim 15, the operations further comprising evaluating the impression value range by calculating one or more of: a precision metric; an estimation rate; an average estimation error; or an average range width.
